(19) United States
(12) Patent Application Publication
(10) Pub. No.: US 2025/0335535 A1
(43) Pub. Date: Oct. 30, 2025

(54) APPLICATION OF THE SCHWINGER OSCILLATOR CONSTRUCT OF ANGULAR MOMENTUM TO AN INTERPRETATION OF THE SUPERCONDUCTING TRANSMON QUBIT

(71) Applicant: Wells Fargo Bank, N.A., San Francisco, CA (US)

(72) Inventor: Robert Erickson, Tempe, AZ (US)

(21) Appl. No.: 18/651,150

(22) Filed: Apr. 30, 2024

(51) Int. Cl. G06F 17/13; G06F 17/16

(52) U.S. Cl. CPC G06F 17/13; G06F 17/16

(57) ABSTRACT

Systems and methods are disclosed herein for computing a frequency response spectrum for a superconducting transmon. An example method includes receiving, by communications hardware, an applied voltage function, and computing a first approximation for a set of coefficients of a component form Lindblad master equation, wherein the component form Lindblad master equation is determined using a Hamiltonian based on a Schwinger oscillator model of angular momentum. The example method also includes computing a second approximation for a set of eigenvalue energies of the component form Lindblad master equation and determining a set of coupled differential equations. The example method also includes applying a Runge Kutta method to solve the set of coupled differential equations to obtain a set of matrix elements of a density operator and computing an expectation value of a Schwinger angular momentum component to obtain the frequency response.

### BACKGROUND

The Jaynes-Cummings model has been applied to a superconducting transmon to describe a qubit defined by the two lowest-lying photon states, assuming these states are sufficiently isolated from higher-lying states. The Jaynes-Cummings model has proven invaluable to the understanding of superconducting charge-qubit dynamical behavior. However, the application of the Jaynes-Cummings model in this simplest form has drawbacks. For example, as mentioned, the two lowest-lying states must be in isolation from those above, which is not always strictly viable, complicating the definition of the qubit and introducing sources of error in measurement of its coherent state, as well as gate operations applied to it.

### BRIEF SUMMARY

The Schwinger oscillator construct of angular momentum, applied to the superconducting transmon and its transmission-line readout, modeled as capacitively coupled quantum oscillators, provides a natural and robust description of a qubit. The construct defines quantum-entangled, two-photon states that form an angular-momentum-like basis, with symmetry corresponding to physical conservation of total photon number, with respect to the combined transmon and readout. This basis provides a convenient starting point from which to study error-inducing effects of transmon anharmonicity, surrounding-environment decoherence, and random stray fields on qubit state and gate operations. Employing a Lindblad master equation to model dissipation to the surrounding environment, and incorporating the effect of weak transmon anharmonicity, example embodiments disclosed herein demonstrate the utility of the construct. First, calculating the frequency response associated with exciting the ground state to a Rabi resonance with the lowest-lying spin-1/2 moment via a driving external voltage is shown. Second, calculating the frequency response between the three lowest two-photon states, within a ladder-type excitation scheme is shown. The generality of the Schwinger angular-momentum construct allows it to be applied to other superconducting charge qubits.

The Jaynes-Cummings model was originally conceived to study spontaneous emission and absorption of photons by atoms isolated in a cavity, with the intent to understand stimulated emission of microwaves via coherent amplification in masers. The model has since been adapted to a superconducting transmon, for example, to describe a qubit defined by the two lowest-lying (ground and excited) photon states, assuming these states are sufficiently isolated from higher-lying states. In this circuit quantum electrodynamics (CQED) model, the qubit (the simulated atom) is capacitively or inductively coupled to a transmission line (the resonator cavity), modeled as a linear quantum oscillator, and driven by an externally applied time-varying field (the interaction). The full quantum wave function of the open transmon-resonator system is estimable in terms of a basis of two-photon equilibrium states constructed from products of transmon and resonator equilibrium states. Usually a transformation of the time-dependent Hamiltonian via the interaction picture is made, from which a rotating-wave approximation of the driving term can be inferred, followed by a transformation of slow-rotation terms to a time-independent Hamiltonian, when possible. Regardless of the set of techniques employed in its solution, the Jaynes-Cummings model has proven invaluable to the understanding of superconducting charge-qubit dynamical behavior.

However, as mentioned previously, the application of the Jaynes-Cummings model in this simplest form has drawbacks. It is not always strictly viable to model the two lowest-lying states in isolation from those above, which requires multilevel extensions to the model. Also, the strength and relative positions of energy levels between qubit and resonator must be engineered to affect as little change on the qubit state during readout as possible, which is counter to the unavoidable intrinsic photon entanglement of the combined transmon and resonator. These issues complicate the definition of the qubit, introducing sources of error in measurement of its coherent state and gate operations applied to it. An alternative is to exploit the tandem design of transmon and resonator, by leveraging the Schwinger oscillator model of angular momentum to construct a more robust definition of the qubit, one rooted in the intrinsic entanglement of the photons, regardless of states excited during operation. This does not change the physics of the device. Instead, it offers a more complete perspective of state entanglement, within the combined transmon and resonator, which can aid device design with respect to quantum decoherence and sources of gate error.

Many years ago, J. Schwinger recognized the equivalence between the Lie algebra of annihilation and creation operators, of two adjoining linear quantum oscillators, and the algebra of angular momentum. This inference has utility in elementary particle physics as a means of demonstrating the property of nuclear isospin, and how it emerges from the entanglement of up and down quarks. This same idea can be applied to the transmon and resonator tandem as well, where both are modeled as full quantum oscillators, allowing for a robust definition of a metric of entanglement, wherein the qubit is a naturally emergent property of the transmon and resonator. However, like nuclear isospin, a qubit defined in this way is not a physical observable of angular momentum, though it possesses the same properties of wave-function construction, operator commutation, and operator addition. Moreover, it is not relegated to a specific spin quantum number, such as spin 1/2, since it is not mapped to a specific state excitation.

Most importantly, the Schwinger construct introduces angular-momentum-like symmetry to the combined transmon and resonator, based on an underlying conservation of total photon number, N. Specifically, as we shall see, N dictates the spin quantum number, S, where S=N/2. This creates an analogy with the simulated atom, as in the original intent of the Jaynes-Cummings model, defining specific angular-momentum-based selection rules that govern allowed state transitions, assuming a fixed value of N. In this way, the angular momentum symmetry becomes a baseline from which to study sources of measurement error, particularly for the transmon, for which anharmonicity is relatively weak compared to other charge qubits. From the point of view of the Schwinger construct, sources of error, such as transmon anharmonicity or stray stochastic fields, are symmetry breaking mechanisms that respectively can cause N to be perturbed from an integer value or cause it to fluctuate randomly, manifestly as noise-induced error.

Example embodiments disclosed herein define the Schwinger qubit construct and apply it to an analysis of transmon excitation, introducing a Lindblad master equation to address dissipation with the surrounding environment. First, the Rabi resonance between ground state and first (spin-1/2) excited state is calculated as a function of the strength of capacitive coupling between transmon and resonator. Second, among the three lowest energy states of combined transmon and resonator, the two Rabi resonances of a ladder-type frequency-response scheme are calculated, showing the viability of this scheme to indirectly excite the third (spin-1) state. Last, symmetry breaking and the exposure of the superconducting transmon to one-half noise are shown.

Accordingly, the present disclosure sets forth systems, methods, and apparatuses that determine a frequency response spectrum of a superconducting transmon. By improving the determination of the frequency response, the operation of quantum computing devices may be improved by reducing error rates due to noise, improving measurements of the coherent state and effectiveness of gate operations.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

FIG. 1 illustrates: (a) the canonical ladder frequency ω_{↓} plotted as a function of capacitive coupling strength g, showing how modes of the ↓ ladder go soft with increasing g, at g_{c}=3.17 GHz, indicative of an instability; (b) magnitude of nonlinear matrix elements of time-independent Hamiltonian, |Δ [symbol] ₒ|, plotted as a heat map, on a relative scale, row index vs column index, with labels indicating blocks of constant S. White regions indicate zero-valued matrix elements, consistent with forbidden state transitions, as discussed herein; and (c) two-photon energy levels plotted in units of GHz as a function of g; as discussed, dashed curves are calculated without anharmonicity while solid curves include anharmonicity via second-order perturbation theory.

FIG. 2 illustrates: (a) real and (b) imaginary parts of off-diagonal matrix element ρ_{1,2}(t) plotted as a function of time t, where off-diagonal element ρ_{2,1}(t)=ρ_{1,2}(t)*; (c) diagonal matrix clement ρ_{2,2}(t) plotted as a function of time t, where ρ_{1,1}(t)=1−ρ_{2,2}(t); the left-hand side curve is the Runge Kutta numerical solution while the right-hand side is the asymptote of the steady-state limit, as t→∞, as discussed herein, and (d) plot of Runge-Kutta estimated [symbol] S_{z}(t₂) [symbol] , where t₂=100 μs, as a function of the frequency of the driving voltage, Ω.

FIG. 3 illustrates plots of [symbol] S_{z}(t₂) [symbol] , where t₂=100 μs, as a function of driving frequency Ω, for several values of capacitive coupling parameter g, as indicated in the figure.

FIG. 4A illustrates plots of Runge-Kutta-evaluated elements of the density matrix ρ(t) of the ladder-type state-excitation scheme as a function of time t. The top plot represents the diagonal elements, middle plots depict the real parts of off-diagonal element ρ_{1,2}(t). The imaginary part of the same matrix element is shown in the bottom plot.

FIG. 4B illustrates plots of Runge-Kutta-evaluated elements of the density matrix ρ(t) of the ladder-type state-excitation scheme as a function of time t. The top plot represents the diagonal elements, middle plots depict the real parts of off-diagonal element ρ_{1,3}(t). The imaginary part of the same matrix element is shown in the bottom plot.

FIG. 4C illustrates plots of Runge-Kutta-evaluated elements of the density matrix ρ(t) of the ladder-type state-excitation scheme as a function of time t. The top plot represents the diagonal elements, middle plots depict the real parts of off-diagonal clement ρ_{2,3}(t). The imaginary part of the same matrix element is shown in the bottom plot.

FIG. 5 illustrates a system in which some example embodiments may be used for computing a frequency response spectrum for a superconducting transmon.

FIG. 6 illustrates a schematic block diagram of example circuitry embodying a transmon frequency response system that may perform various operations in accordance with some example embodiments described herein.

FIG. 7 illustrates an example flowchart for computing a frequency response spectrum for a superconducting transmon, in accordance with some example embodiments described herein.

### DETAILED DESCRIPTION

Disclosed herein are the model Hamiltonian of the combined transmon and resonator, followed by a definition of the qubit of this Hamiltonian via the Schwinger oscillator model of angular momentum. Finally, the voltage driving term and the Lindblad master equation are disclosed, whose solution is used to calculate the expectation value of the qubit.

### Theory

### The Transmon and Resonator Hamiltonian

Disclosed herein is a model of a superconducting transmon of charging energy E_{C} and Josephson energy E_{J} as an anharmonic quantum oscillator, where the cosine of the superconducting phase is expanded as a Taylor series, in a Duffing approximation, and the offset charge number is assumed negligible or otherwise removable from the resulting Hamiltonian. Denoting the transmon oscillator ladder by index −, its fundamental frequency is ω_=\sqrt{8E_{C}E_{J}}/h. Similarly, representing the resonator as a linear quantum oscillator of self-inductance L and capacitance C, and denoting its ladder by index +, a fundamental frequency ω₊=1/\sqrt{LC} is found. With the two oscillators capacitively coupled via parameter g, the second-quantized Hamiltonian may be expressed as

$${ℋ}_{o} = {\sum }_{μ = \pm } ℏ {ω}_{μ} ( {a}_{μ}^{†} {a}_{μ} + \frac{1}{2} ) + \frac{1}{4} i ℏ \tilde{g} ( {a}_{+}^{†} + {a}_{+} ) ( {a}_{-}^{†} - {a}_{-} ) - \frac{1}{12} {{E}_{C} ( {a}_{-}^{†} + {a}_{-} )}^{2} , \qquad ( 1 )$$

where \tilde{g}=g\sqrt{ℏω_/E_{C}} and α_{μ},

$${a}_{μ}^{†}$$

are annihilation and creation operators, respectively, with commutation relations

$$[ {a}_{μ} , {a}_{{μ}^{′}}^{†} ] = {δ}_{μ , {μ}^{′}} , [ {a}_{μ} , {a}_{{μ}^{′}} ] = 0 and [ {a}_{μ}^{†} , {a}_{{μ}^{′}}^{†} ] = 0 .$$

Applying a canonical transformation to (1) to diagonalize linear terms arrives at

$${ℋ}_{o} = {\sum }_{σ ∈ \{ ↑ , ↓ \}} ℏ {ω}_{σ} ( {a}_{σ}^{†} {a}_{σ} + \frac{1}{2} ) - \frac{1}{12} {{E}_{C} [ {ξ}_{↑ , -} ( {a}_{↑}^{†} - {a}_{↑} ) - i {ξ}_{↓ , -} ( {a}_{↓}^{†} + {a}_{↓} ) ]}^{4} , \qquad ( 2 )$$

where ↑, ↓ are indexes denoting the canonical ladders of fundamental frequency:

$${ω}_{σ} = \sqrt{\frac{1}{2} [ {ω}_{+}^{2} + {ω}_{-}^{2} + σ \sqrt{{( {ω}_{+}^{2} - {ω}_{-}^{2} )}^{2} + {\tilde{g}}^{2} {ω}_{+} {ω}_{-}} ]} , \qquad ( 3 )$$

and

$${ξ}_{σ , μ} = \sqrt{( {ω}_{σ} / {ω}_{μ} ) ( {ω}_{μ}^{2} - {ω}_{σ}^{2} ) / ( {ω}_{σ}^{2} - {ω}_{σ}^{2} )} .$$

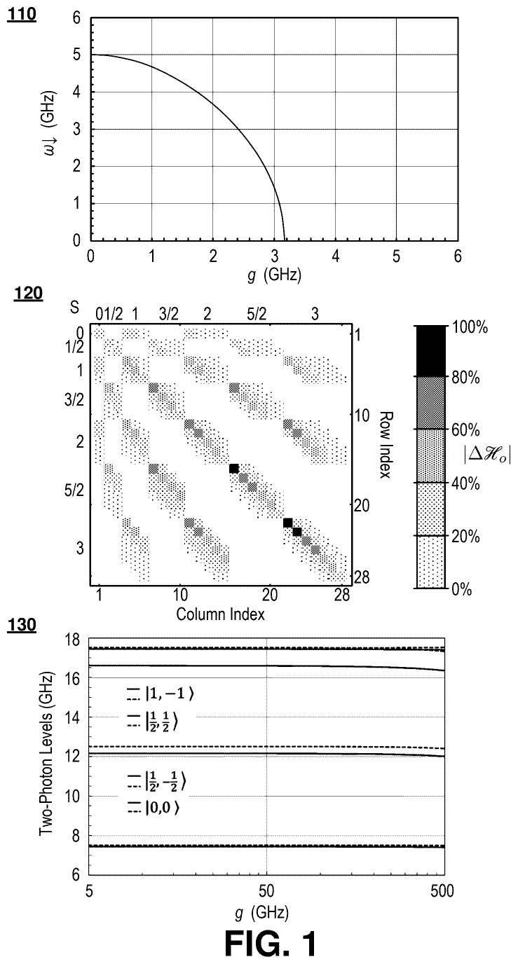

In this notation, the numerical value of σ is +1 (−1) when index σ=↑ (σ=↓), with additional index notations μ̅=−μ and σ̅=↓ (σ̅=↑) when σ=↑ (σ=↓). Note that as g, or equivalently \tilde{g}, increases then ω_{↓}→0, as in plot 110 of FIG. 1, indicative of instability; hence, examples herein assume the transmon is weakly coupled to the resonator. In this weak-coupling limit, the ↑ (↓) canonical ladder is most strongly identifiable with the +(−) original ladder as

$${ω}_{↑} ≅ {ω}_{+} + {\tilde{g}}^{2} {ω}_{-} / [ 8 ( {ω}_{+}^{2} - {ω}_{-}^{2} ) ] and {ω}_{↓} ≅ {ω}_{-} + {\tilde{g}}^{2} {ω}_{+} / [ 8 ( {ω}_{+}^{2} - {ω}_{-}^{2} ) ] .$$

### The Schwinger Oscillator Model of Angular Momentum

Slow-rotation constituents of [symbol] ₒ can be expressed in terms of number operators

$${n}_{σ} {a}_{σ}^{†} {a}_{σ}$$

and Schwinger angular momentum components, the latter of which are defined as

$${S}_{+} = {a}_{↑}^{†} {a}_{↓} , {S}_{-} = {a}_{↓}^{†} {a}_{↑} , \qquad ( 4 )$$

$${S}_{x} = \frac{1}{2} ( {S}_{+} + {S}_{-} ) , {S}_{y} = \frac{1}{2 i} ( {S}_{+} - {S}_{-} ) , {S}_{z} = \frac{1}{2} ( {a}_{↑}^{†} {a}_{↑} - {a}_{↓}^{†} {a}_{↓} ) , \qquad ( 5 )$$

The length S=N/2, proportional to total number operator N, is a good quantum number in the absence of nonlinear (anharmonic) terms in [symbol] ₒ. The Cartesian operator components Sₓ, S_{y}, and S_{z}, whose expectation values define the qubit, satisfy the usual commutation relations of angular momentum, i.e., [Sⱼ, Sₖ]=ϵ_{j,k,l}Sₗ, where j, k, l∈{x, y, z} and ϵ_{j,k,l} is a Levi-Civita coefficient. This result follows from the commutation relations of α_{σ} and

$${a}_{σ}^{†} .$$

Similarly, via an inverse canonical transformation, the Schwinger angular momentum components also can be expressed in terms of α_{μ} and

$${a}_{μ}^{†} ,$$

with preservation of [Sᵢ, Sⱼ]=iϵ_{i,j,k}Sₖ.

In the linear limit of EQ. 2, eigenstates are two-particle states |n_{↑} [symbol] ⊗|n_{↑} [symbol] , where α_{σ}|n_{σ} [symbol] =\sqrt{n_{σ}}|n_{σ}−1 [symbol] and α_{σ}^{†}|n_{σ} [symbol] =\sqrt{n_{σ}+1}|n_{σ}+1), with eigenvalues E_{n↑,n↓}=Σ_{σ}ℏω_{σ}(n_{σ}+1/2). In this limit, angular momentum states are identical to two-particle energy eigenstates, but with reordered indexing, such that an angular momentum state is of the form

$$\vert S , {m}_{S} 〉 = \frac{{a}_{↑}^{{†}^{S + {m}_{S}}} \vert 0 〉 ⊗ {a}_{↓}^{{†}^{S - {m}_{S}}} \vert 0 〉}{\sqrt{( S + {m}_{S} ) ! ( S - {m}_{S} ) !}} , \qquad ( 6 )$$

where |0,0 [symbol] =|0 [symbol] ⊗|0 [symbol] is the vacuum state, length S=(n_{↑}+n_{↓})/2=0, 1/2, 1, . . . , and quantum number m_{S}(n_{↑}n_{↓})/2=−S, −S+1, . . . , S−1, S. Thus, |S, m_{S} [symbol] is an eigenstate of the linear Hamiltonian, with eigenvalue ℏξ_{S,ms}, where

$${ξ}_{S , {m}_{S}} = ( {ω}_{↑} - {ω}_{↓} ) ( S + \frac{1}{2} ) + ( {ω}_{↑} - {ω}_{↓} ) {m}_{S} . \qquad ( 7 )$$

Since operators S_{±} of EQ. 4 are legitimate angular momentum operators, the identities

$${S}_{\pm } \vert S , {m}_{S} 〉 = \sqrt{( S ∓ {m}_{S} ) ( S \pm {m}_{S} + 1 )} \vert S , {m}_{S} \pm 1 〉 , \qquad ( 8 )$$

also hold. Note that states |S, m_{S} [symbol] of EQ. 6 are symmetric since the particles of the combined oscillators are bosons.

An important point to note is that the Schwinger construct introduces selection rules via the angular-momentum symmetry, associated with constant N. To see this, consider defining the nonlinear terms of [symbol] ₒ of EQ. 2 as

$${Δℋ}_{o} = - \frac{1}{12} {{E}_{c} [ {ξ}_{↑ , -} ( {a}_{↑}^{†} - {a}_{↑} ) - i {ξ}_{↓ , -} ( {a}_{↓}^{†} + {a}_{↓} ) ]}^{4} . \qquad ( 9 )$$

Let two-photon eigenstates of [symbol] ₒ be denoted by |ψₖ [symbol] , with indexes k=1,2, . . . , such that [symbol] ₒ|ψₖ [symbol] =ℏϵₖ|ψₖ), where ℏϵₖ is an eigenstate energy. For the transmon, where the anharmonicity is weak, i.e., E_{C}<<12ℏω_{↓}, we can use standard Rayleigh-Schrödinger time-independent perturbation theory to evaluate |ψₖ [symbol] and ϵₖ, using the states |S, m_{S} [symbol] of EQ. 6 as a basis.

In plot 120 of FIG. 1, the relative magnitude of the matrix elements [symbol] ψₖ|Δ [symbol] ₒ|ψ_{k′}), for k, k′=1, 2, . . . , (S+1) (2S+1), is illustrated as a heat map, evaluating [symbol] ψₖ| and |ψ_{k′}) to second order in the perturbation expansion, using a subset of states |S, m_{S} [symbol] , up to S=3. Plot 120 also shows the relative magnitude of each element by row (k) and column (k′), where white space denotes a magnitude of zero. Rows k and columns k′ are indicated on the right and bottom edges of the heat map, respectively. The left and top edges of the heat map are labeled with the spin quantum numbers most closely identifiable (from the perturbation theory) with indexes k and [symbol] . The elements [symbol] ψₖ|Δ [symbol] ₒ|ψ_{k′} [symbol] are shown to form well-defined blocks of non-zero sub matrices according to the value of spin S, with large non-zero magnitudes aligned in bands parallel to the matrix diagonal.

In zero order of the perturbation expansion, only blocks of matrices along the diagonal—rows and columns of the same value of S—would be non-zero. In second order of the perturbation theory, however, plot 120 shows that non-zero blocks extend to bands on either side of the non-zero diagonal blocks, but only for sub matrices where the row-value of S and the column-value of S differ by an integer value. This indicates that, for the superconducting transmon, atom-like selection rules apply, even in the presence of weak anharmonicity. In this specific situation, allowed state transitions are associated with integer change in the value of spin; half-integer changes in spin are essentially forbidden. Hence, since S=N/2, this means that the transmon tends to be robust against changes in N that involve an odd number of photons, such as those associated with random one-half noise events. In contrast, changes in N by an even number of photons include events such as pairwise adiabatic, elastic collisions that conserve linear momentum, as when the transmon-resonator system is subjected to a coherent applied voltage.

Lastly, FIG. 1 shows the form of energy levels ℏϵₖ calculated from the second-order perturbation theory. Specifically, plot 130 illustrates the two-photon ϵₖ, measured in GHz, as a function of capacitive coupling strength g, also measured in GHZ, for the first four energy levels. The dashed curves are the zero-order, unperturbed values—the same as EQ. 7—plotted for comparison with the solid-curve, second-order estimates of ϵₖ. The curves are labeled by the kets of their zero-order correspondences. Note that the purple solid curve (|1,−1 [symbol] ) is lower in value than that of the green solid curve

$$( \vert \frac{1}{2} , \frac{1}{2} 〉 ) ,$$

a juxtaposition indicative of an avoided crossing, resulting from the anharmonicity.

### The Driving Voltage and Lindblad Master Equation

Example embodiments may model the interaction of the qubit with an externally applied field by introducing a time-dependent energy term [symbol] (t)=−q₊V(t), where V(t) is the driving voltage and q₊ is the charge of the resonator. [symbol] (t) can be expressed in second-quantized form, within the canonical representation, as

$$( t ) = - ℏΘ V ( t ) , \qquad ( 10 )$$

$$Θ = {v}_{↑} ( {a}_{↑}^{†} + {a}_{↑} ) + {iv}_{↓} ( {a}_{↓}^{†} - {a}_{↓} ) ; {v}_{σ} = \frac{1}{\sqrt{2 ℏ Z}} ( \frac{{ω}_{+}}{{ω}_{σ}} ) {ξ}_{σ , +} . \qquad ( 11 )$$

In this way, the Hamiltonian is modified to an open time-dependent form [symbol] (t)= [symbol] ₒ+ [symbol] (t).

Additionally, to complete the description of the open system, example embodiments may model the interaction of transmon and resonator with the surrounding environment via a Lindblad master equation, where γ_{μ}^{′} and γ_{μ} are diffusion and dissipation rates, respectively, between environment and resonator (μ=+), and environment and transmon (μ=−). As alluded to earlier, in plot 110 of FIG. 1, example embodiments may assume |\tilde{g}|<<4ω_{μ}, such that, to first approximation, embodiments may neglect diffusion and dissipation directly between transmon and resonator. The canonical form of the Lindblad master equation can be expressed as

$$\frac{d ρ ( t )}{d t} = \frac{1}{i ℏ} [ ℋ ( t ) , ρ ( t ) ] + \frac{1}{2} {\sum }_{σ , {σ}^{′} ∈ \{ ↑ , ↓ \}} {\sum }_{s , {s}^{′} = \pm } {γ}_{σ , s ; {σ}^{′} , {s}^{′}} [ 2 {A}_{σ , s} ρ ( t ) {A}_{{σ}^{′} {s}^{′}}^{†} - {A}_{{σ}^{′} {s}^{′}}^{†} {A}_{σ , s} ρ ( t ) - ρ ( t ) {A}_{{σ}^{′} {s}^{′}}^{†} {A}_{σ , s} ] \qquad ( 12 )$$

where ρ(t) is a density operator, A_{σ,+}=α_{σ} and

$${A}_{σ , -} = {a}_{σ}^{†}$$

are jump operators, and

$${γ}_{σ , s ; {σ}^{′} , {s}^{′}} = \frac{1}{4} {\sum }_{μ , m = \pm } {γ}_{μ , m} {ξ}_{σ , m} {ξ}_{{σ}^{′} , μ} ( \frac{{ω}_{μ} + m s {ω}_{σ}}{{ω}_{σ}} ) ( \frac{{ω}_{μ} + m {s}^{′} {ω}_{{σ}^{′}}}{{ω}_{{σ}^{′}}} ) \times {e}^{i π [ ( σ - {σ}^{′} ) m ( 1 - μ ) - s ( 1 - σ ) + {s}^{′} ( 1 - {σ}^{′} ) ] / 4 ,} with {γ}_{μ , m} = ( {γ}_{μ} + {γ}_{μ} ) {δ}_{m = +} + ( {γ}_{μ} - {γ}_{μ} ) {δ}_{m = -} . \qquad ( 13 )$$

In practice, example embodiments may solve EQ. 12 in component form by defining matrix elements of ρ(t) using the energy states |ψₖ [symbol] of [symbol] ₒ as a basis, calculated from the second-order perturbation theory described earlier. We then have matrix elements ρ_{k,k′}(t)= [symbol] ₖ|ρ(t)|ψ_{k′} [symbol] , as well as Θ_{k,k′}= [symbol] ₖ|Θ|ψ_{k′} [symbol] for Θ of EQ. 11, and A_{k,k′}(σ,s)= [symbol] ₖ|A_{σ,s}|ψ_{k′} [symbol] for jump operator A_{σ,s}. Example embodiments may also truncate the infinite set of coupled differential equations to only those that interact strongly with V(t), labeling this finite set of states by ε. In this way, example embodiments may set ρ_{k,k′}(t)=0 unless k, k′∈ε, such that the component form of EQ. 12 is approximated as

$$\frac{d {ρ}_{k , {k}^{′}} ( t )}{d t} ≅ \text{} - i ( {ϵ}_{k} - {ϵ}_{{k}^{′}} ) {ρ}_{k , {k}^{′}} ( t ) + {\sum }_{l , {l}^{′} ∈ ℰ} [ i ( {Θ}_{k , l} {δ}_{{k}^{′} , {l}^{′}} - {Θ}_{{l}^{′} , {k}^{′}} {δ}_{k , l} ) V ( t ) + {Λ}_{k , {k}^{′}}^{l , {l}^{′}} ] {ρ}_{l , {l}^{′}} ( t ) , \qquad ( 14 )$$

where k, k′∈ε and the coefficients are defined as

$${Λ}_{k , {k}^{′}}^{( l , {l}^{′} )} = \frac{1}{2} {\sum }_{σ , {σ}^{′} ∈ \{ \}} {\sum }_{s , {s}^{′} = \pm } {γ}_{σ , s ; {σ}^{′} , {s}^{′}} \{ 2 {A}_{k , l} ( σ , s ) {{A}_{{k}^{′} , {l}^{′}} ( {σ}^{′} , {s}^{′} )}^{*} - {\sum }_{{k}^{″} ∈ ℰ} [ {{A}_{{k}^{″} , k} ( {σ}^{′} {s}^{′} )}^{*} {A}_{{k}^{″} , l} ( σ , s ) {δ}_{{k}^{′} , {l}^{′}} + {{A}_{{k}^{″} , {l}^{′}} ( {σ}^{′} , {s}^{′} )}^{*} {A}_{{k}^{″} , {k}^{′}} ( σ , s ) {δ}_{k , l} ] \} \qquad ( 15 )$$

indicative of the strength of interaction with the surroundings. Similar to ρ_{k,k′}(t), a matrix element of the expectation value of a Schwinger spin component can be expressed as

$${S}_{k , {k}^{′}}^{( α )} = {k}_{} \vert {S}_{α} \vert {ψ}_{{k}^{′}} 〉 ,$$

where α∈{x, y, z}, such that [symbol] S(t) [symbol] =Tr[Sρ(t)] can be approximated as

$$( t ) 〉 ≅ {\sum }_{α ∈ \{ x , y , z \}} {\sum }_{k , {k}^{′} ∈ ℰ} {S}_{k , {k}^{′}}^{( α )} {ρ}_{{k}^{′} , k} ( t ) \hat{α} \qquad ( 16 )$$

where \hat{α} represents a unit vector of the abstract Cartesian coordinate system.

### Results

The following calculations use the parameters listed below in Table I, unless otherwise stated. For concreteness, regarding the resonator, calculations take the self-inductance to be L=10.0 pH and the capacitance to be C=1.0 nF, such that ω₊=1/\sqrt{LC}=10.0 GHz. For the transmon, the calculations assume E_{J}/E_{C}=50 and take ω_=5.0 GHz, which requires E_{C}=0.165 μeV and E_{J}=8.24 μeV. Also, the calculations set the diffusion and dissipation rates of EQ. 12 to values that correspond to coherence times in the range of 100 μs, allowing the resonator to be more interactive with the surrounding environment than the transmon, with γ₊^{′}=100 kHz, γ₊=10.0 kHz and γ_=10.0 kHz, γ_=1.0 kHz.

TABLE I
Model parameters of transmon and resonator as utilized herein.

| Resonator | | | | Transmon | | | | |
|---|---|---|---|---|---|---|---|---|
| L (pH) | C (nF) | γ′₊(kHz) | γ₊(kHz) | E_{C}(μeV) | E_{J}(μeV) | γ′₋(kHz) | γ₋(kHz) | g (MHz) |
| 10.0 | 1.0 | 100.0 | 10.0 | 0.165 | 8.24 | 10.0 | 1.0 | 5.0 |

Results are shown for excitation of the ground state to the lowest-lying excited state of the transmon-resonator system, corresponding to an induced qubit of spin-1/2, near the Rabi resonance frequency, using a single-tone applied voltage. This calculation uses the two lowest-lying energy levels in plot 130 of FIG. 1. This analysis derives the coherence time of the qubit, which is set, via Table I, to correspond to about 100 μs. Also, this analysis extends the two-state calculation to consider the frequency response as a function of increasing g. In a second set of results, the analysis applies a two-tone voltage and explore the excitation of the ground state to the two lowest-lying states of spin-1/2 and spin-1, respectively, within a Rabi resonance calculation corresponding to a three-state, ladder-type frequency-response scheme. Again, calculations make use of plot 130 of FIG. 1, but in this case using the three lowest-lying energy levels. This three-state resonance calculation demonstrates the excitation of the Schwinger qubit to a superposition that includes the spin-1/2 and spin-1 states.

### A Single-Tone Two-State Rabi Resonance Calculation

First considering the solution of EQ. 12 for a Rabi resonance between the two lowest-lying states, ε={1,2}, a single-tone voltage, V(t)=VₒsinΩt, with Vₒ=1.0 nV, was applied for values of pump frequency Ω≈ϵ_{2,1}, where ϵ_{2,1}=ϵ₂−ϵ₁. Since transmon anharmonicity is weak, a first approximation is made of coefficients Θ_{k,k′} and A_{k,k′}(σ, s), and thereby

$${Λ}_{k , {k}^{′}}^{( l , {l}^{′} )} ,$$

by taking |ψ₁ [symbol] ≅|0,0 [symbol] and |ψ₂ [symbol] ≅|1/2,−1/2 [symbol] . For the two eigenvalue energies, EQ. 7 is used such that ϵ₁≅ξ_{0,0} and ϵ₂≅ξ_{1/2,-1/2}.

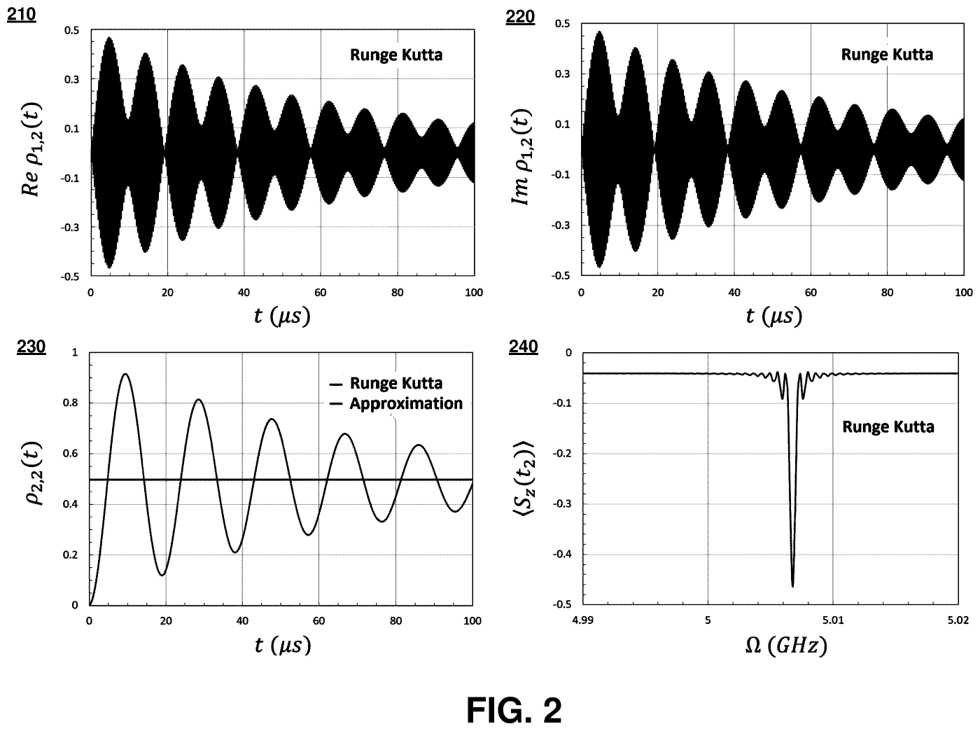

Applying a Runge Kutta numerical method, the four coupled differential equations are solved to obtain the solution presented in FIG. 2. With Ω≅ϵ_{2,1}, corresponding to detuning of 50 kHz, plot 210 and plot 220 of FIG. 2 show the real and imaginary parts of ρ_{1,2}(t) as a function of t, respectively, while plot 230 displays the solution of ρ_{2,2}(t) as a function of t. The other two elements of the density matrix are ρ_{2,1}(t)=ρ_{1,2}(t)* and ρ_{1,1}(t)=1−ρ_{2,2}(t). Also, using EQ. 16, the z-component of the induced spin-1/2 qubit is shown in plot 240, [symbol] S_{z}(t₂) [symbol] ≅−ρ_{2,2}(t)/2, where t₂=100 μs, as a function of pump frequencies centered about the Rabi frequency; the x and y components of spin are zero and not displayed.

An approximate solution applicable to the steady-state, i.e., as t→∞, may also be derived. In this approximation the off-diagonal density-matrix elements are purely oscillatory as a function of t, as t→∞, with an asymptotic form

$${ρ}_{1 , 2} ( t ) ≅ \frac{1}{2} ( \frac{{Λ}_{1 , 1}^{( 2 , 2 )} + {Λ}_{1 , 1}^{( 1 , 1 )}}{{Λ}_{1 , 1}^{( 2 , 2 )} - {Λ}_{1 , 1}^{( 1 , 1 )}} ) [ \frac{{θ}_{1 , 2} {Λ}_{1 , 2}^{( 1 , 2 )} {V}_{o} {e}^{i Ω t}}{{( Ω - {\tilde{ϵ}}_{2 , 1} )}^{2} + {Δ}_{2 , 1}^{2}} ] . \qquad ( 17 )$$

In contrast, the leading contribution to the diagonal density-matrix elements are constant in t as t→∞. For example,

$${ρ}_{2 , 2} ( t ) ≅ \frac{- 1}{{Λ}_{1 , 1}^{( 2 , 2 )} - {Λ}_{1 , 1}^{( 1 , 1 )}} \{ {Λ}_{1 , 1}^{( 1 , 1 )} + \frac{1}{2} ( \frac{{Λ}_{1 , 1}^{( 2 , 2 )} + {Λ}_{1 , 1}^{( 1 , 1 )}}{{Λ}_{1 , 1}^{( 2 , 2 )} - {Λ}_{1 , 1}^{( 1 , 1 )}} ) [ \frac{{\vert {θ}_{1 , 2} \vert}^{2} {Λ}_{1 , 2}^{( 1 , 2 )} {V}_{o}^{2}}{{( Ω - {\tilde{ϵ}}_{2 , 1} )}^{2} + {Δ}_{2 , 1}^{2}} ] \} , \qquad ( 18 )$$

which is also shown in plot 230 of FIG. 2 as the horizontal line. The asymptotes of ρ_{1,1}(t) and ρ_{2,2}(t) are the final, steady-state probability distributions achieved by virtue of the applied voltage. Also, within this approximation, [symbol] S(t) [symbol] ≅−ρ_{2,2}(t)\hat{z}/2, which implies

$$〈 S ( t ) 〉 ≅ \frac{1}{2 ( {Λ}_{1 , 1}^{( 2 , 2 )} - {Λ}_{1 , 1}^{( 1 , 1 )} )} \{ {Λ}_{1 , 1}^{( 1 , 1 )} + \frac{1}{2} ( \frac{{Λ}_{1 , 1}^{( 2 , 2 )} + {Λ}_{1 , 1}^{( 1 , 1 )}}{{Λ}_{1 , 1}^{( 2 , 2 )} - {Λ}_{1 , 1}^{( 1 , 1 )}} ) [ \frac{{\vert {θ}_{1 , 2} \vert}^{2} {Λ}_{1 , 2}^{( 1 , 2 )} {V}_{o}^{2}}{{( Ω - {\tilde{ϵ}}_{2 , 1} )}^{2} + {Δ}_{2 , 1}^{2}} ] \} \hat{z} . \qquad ( 19 )$$

Note in the frequency response of EQS. 17-19 that the energy difference ϵ_{2,1} undergoes a small shift, by virtue of the applied voltage, to a new value

$${\tilde{ϵ}}_{2 , 1} = {ϵ}_{2 , 1} - [ \frac{2 {\vert {θ}_{1 , 2} \vert}^{2} {Λ}_{1 , 2}^{( 1 , 2 )} + ( {θ}_{1 , 2}^{2} + {θ}_{2 , 1}^{2} ) {Λ}_{1 , 2}^{( 2 , 1 )}}{4 {ϵ}_{2 , 1} ( {Λ}_{1 , 1}^{( 2 , 2 )} - {Λ}_{1 , 1}^{( 1 , 1 )} )} ] {V}_{o}^{2} . \qquad ( 20 )$$

Also, the half-width at half maximum is

$${Δ}_{2 , 1} ≅ \frac{1}{τ} \sqrt{1 + \frac{1}{2} {\vert {θ}_{1 , 2} \vert}^{2} {V}_{o}^{2} {τ}^{2}} ; τ = \frac{1}{\vert {Λ}_{1 , 1}^{( 1 , 2 )} \vert} , \qquad ( 21 )$$

where τ is a coherence time, with τ≅100.0 μs in the present calculation. EQ. 21 is similar in form to that obtainable from the Bloch equation of motion, except here τ is a single relaxation time governing the Lorentzian half-width, as opposed to the two longitudinal and transverse relaxation times of the Bloch equation. The Bloch-like result follows from a specific semi-classical treatment of the Lindblad master equation. In the present quantum-limit result, EQS. 17-21 are most applicable when t >>τ.

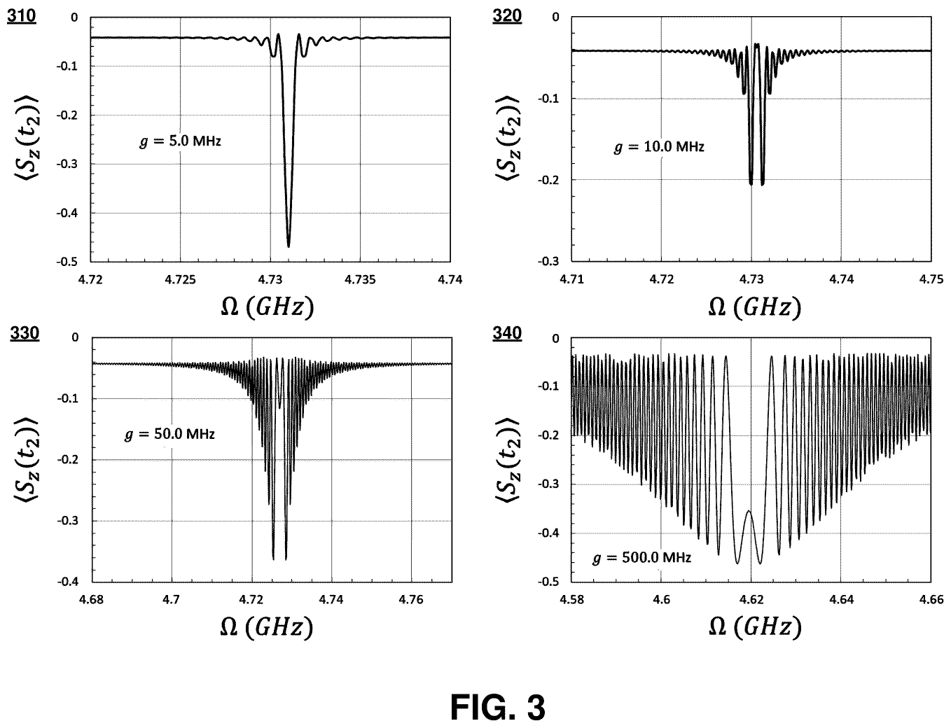

As a last part of the analysis of the two-state excitation, the Rabi resonance is considered as a function of increasing g, using second-order perturbation theory to estimate |ψ₁ [symbol] and |ψ₂ [symbol] , as well as ϵ₁ and ϵ₂. Specifically, FIG. 3 shows the Runge-Kutta calculation of [symbol] S_{z}(t) [symbol] as a function of Ω for several increasing values of g, starting from g=5 MHz in plot 310. Note that plot 240 of FIG. 2, of the previous calculation, and the new plot 310 of FIG. 3 differ only in the estimate of |ψ₁ [symbol] , |ψ₂ [symbol] , ϵ₁, and ϵ₂. The greatest difference between the two plots is the resonance-frequency downward shift, by about 300 MHz, in plot 310, attributable to inclusion of the second-order perturbation.

Second-order perturbation theory applied in FIG. 3, is able to capture an avoided crossing involving the third and fourth energy levels, as discussed earlier with respect to plot 130 of FIG. 1. Also, the calculation assumes the resonator interacts more strongly with the surrounding environment than does the transmon, with diffusion and dissipation rates given in Table I. These factors allowed for exploring the interplay between transmon-resonator states and polaritons that form in the presence of the driving voltage more fully, particularly with increasing g.

In FIG. 3, as g increases from g=5.0 MHz, in plot 310, to g=10.0 MHz, in plot 320, a gap initially opens in the frequency-response spectrum centered about Ω=\tilde{ϵ}_{2,1}, indicative of transparency at that frequency, with \tilde{ϵ}_{2,1} shifting lower as g increases. At g=10.0 MHz, the transparency is nearly maximal, but as g increases there is a non-monotonic character to the transparency, with an increasing number of sidebands appearing in the frequency response, as g increases to 50.0 MHz in plot 330, which tend to overwhelm any apparent gap. For example, when g=500 MHz in plot 340 of FIG. 3, the transparency has essentially disappeared.

### A Two-Tone Three-State Rabi Resonance Calculation

The next calculation considers the solution of EQ. 14 for Rabi resonances between the three lowest-lying states, for which E={1,2,3}. In this situation, matrix coefficients Θ_{k,k′}= [symbol] ψₖ|Θψ_{k′} [symbol] , of the operator defined in EQ. 11, couple the applied voltage to the two excited states, |ψ₂ [symbol] and |ψ₃ [symbol] . However, since Θ_{1,3}=Θ_{1,3}=0, there can be no direct excitation of state |ψ₃ [symbol] from the ground state. To overcome this forbidden transition, a ladder scheme can be employed to excite |ψ₁ [symbol] →|ψ₂ [symbol] and |ψ₂ [symbol] →|ψ₃ [symbol] . This is accomplished by applying a two-tone voltage, V(t)=VₚsinΩₚt+V_{c}sinΩ_{c}t. Here the calculation sets Vₚ=0.5 nV and V_{c}=1.0 nV, and adjusts the two frequencies to obtain Rabi resonances Ωₚ≈ϵ_{2,1} and Ω_{c}≈ϵ_{3,2}, where ϵ_{k,k′}=ϵₖ−ϵ_{k′}. The calculation sets the detuning to 50 kHz for both Rabi resonances. The states |ψₖ [symbol] and ϵₖ were estimated from second-order perturbation theory, and a Runge-Kutta method was applied to solve the coupled differential equations of EQ. 14.

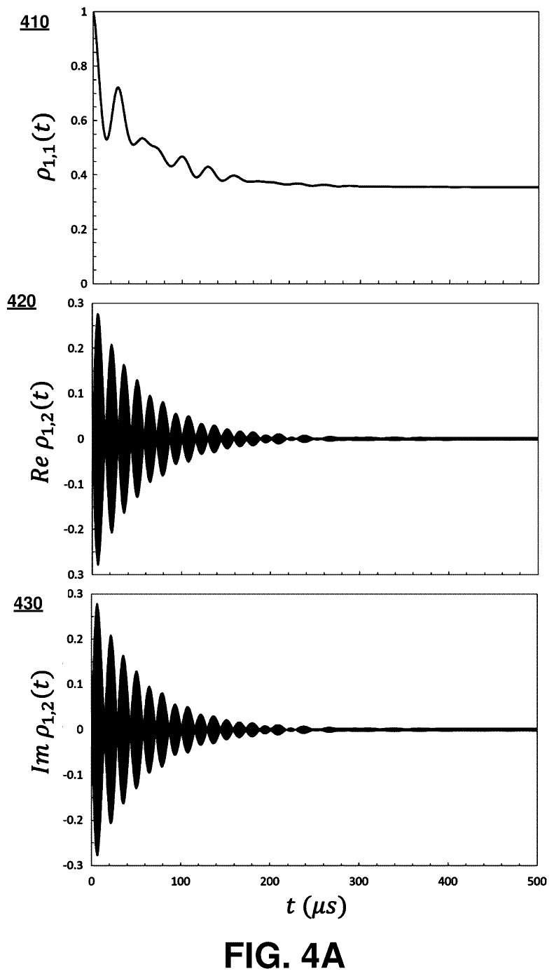

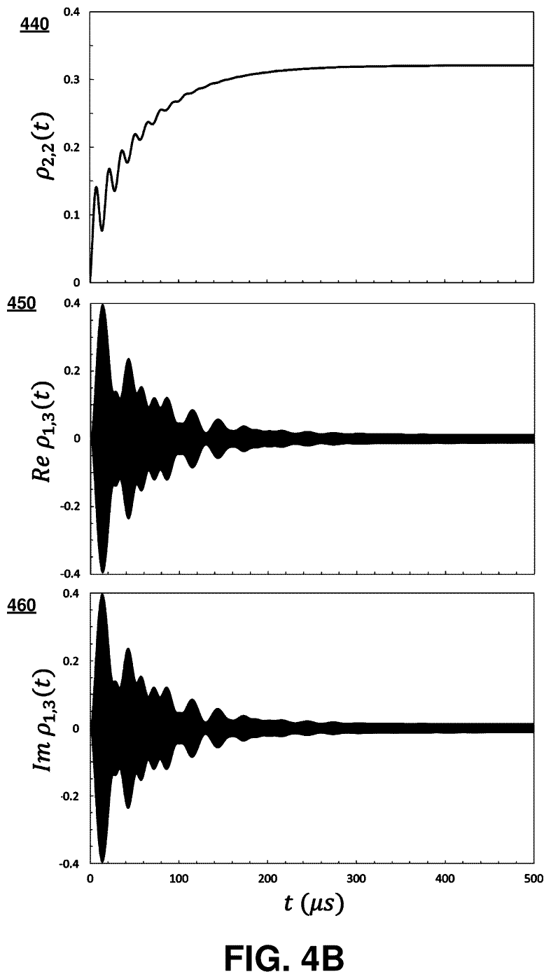

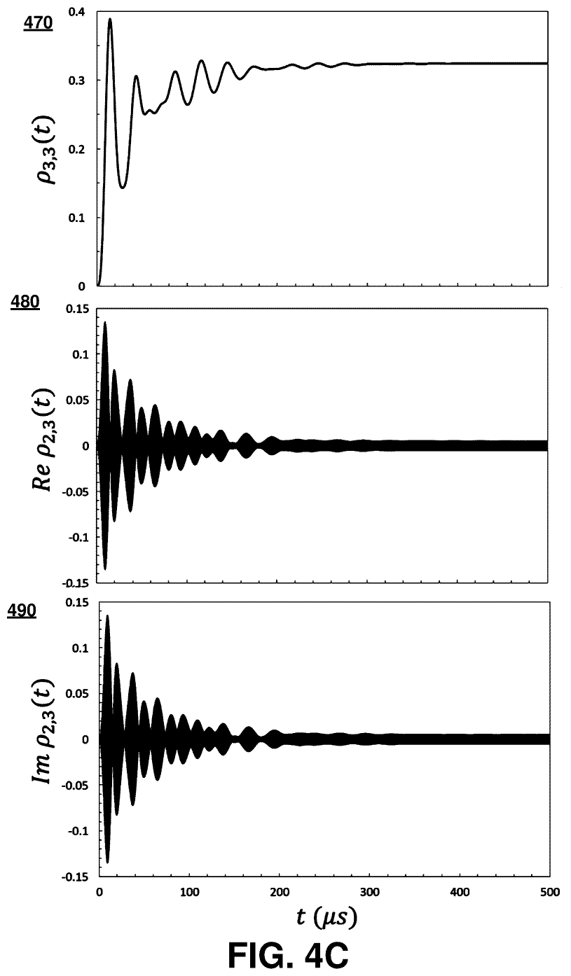

FIG. 4A, FIG. 4B, and FIG. 4C display the solution of the density matrix elements as a function of time for the ladder-type excitation scheme. Plot 410, plot 440, and plot 470 display the behavior of the diagonal elements and the approach to a steady-state distribution of qubit spin. The final, steady state wave function of the system is comprised of a constant admixture of states S=0, S=1/2, and S=1, of approximately ⅓ probability for each. The real parts of ρ_{1,2}(t), ρ_{1,3}(t), and ρ_{2,3}(t) are shown as a function of time in plot 420, plot 450, and plot 480, respectively. Similarly, imaginary parts of ρ_{1,2}(t), ρ_{1,3}(t), and ρ_{2,3}(t) are shown as a function of time in plot 430, plot 460, and plot 490, respectively. Other off-diagonal density-matrix elements are ρ_{2,1}(t)=ρ_{1,2}(t)*, ρ_{3,1}(t)=ρ_{1,3}(t)*, and ρ_{3,2}(t)=ρ_{2,3}(t)*.

### System Architecture

Example embodiments described herein may be implemented using any of a variety of computing devices or servers. To this end, FIG. 1 illustrates an example environment 500 within which various embodiments may operate. As illustrated, a transmon frequency response system 502 may receive and/or transmit information via communications network 504 (e.g., the Internet) with any number of other devices, such as user device 506 and/or quantum computer 508.

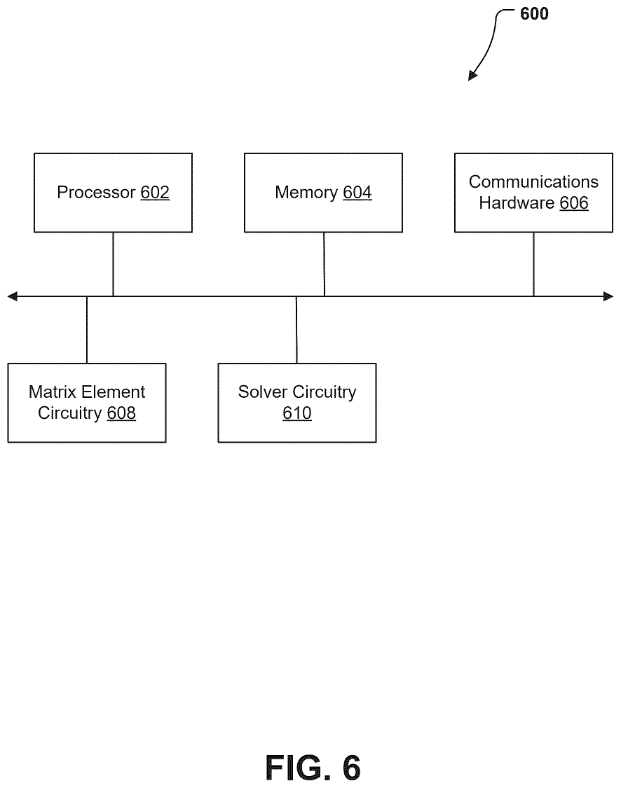

The transmon frequency response system 502 may be implemented as one or more computing devices or servers, which may be composed of a series of components. Particular components of the transmon frequency response system 502 are described in greater detail below with reference to apparatus 600 in connection with FIG. 6.

The user device 506 may be embodied by any computing devices known in the art. The user device 506 need not be an independent device but may be embodied as one or more peripheral devices communicatively coupled to other computing devices.

The quantum computer 508 may be a computing device capable of performing controlled operations on various quantum states embodied as one or more qubits. The quantum computer 508 may be configured to receive quantum circuits including a series of quantum gate operations performed on the one or more qubits of the quantum computer 508. A qubit of the quantum computer 508 may be embodied as a transmon, a type of superconducting charge qubit. The quantum computer 508 may be configured to receive calibration, configuration, or other information via communications network 504 to configure the manipulation of a transmon and/or other qubits.

### Example Implementing Apparatuses

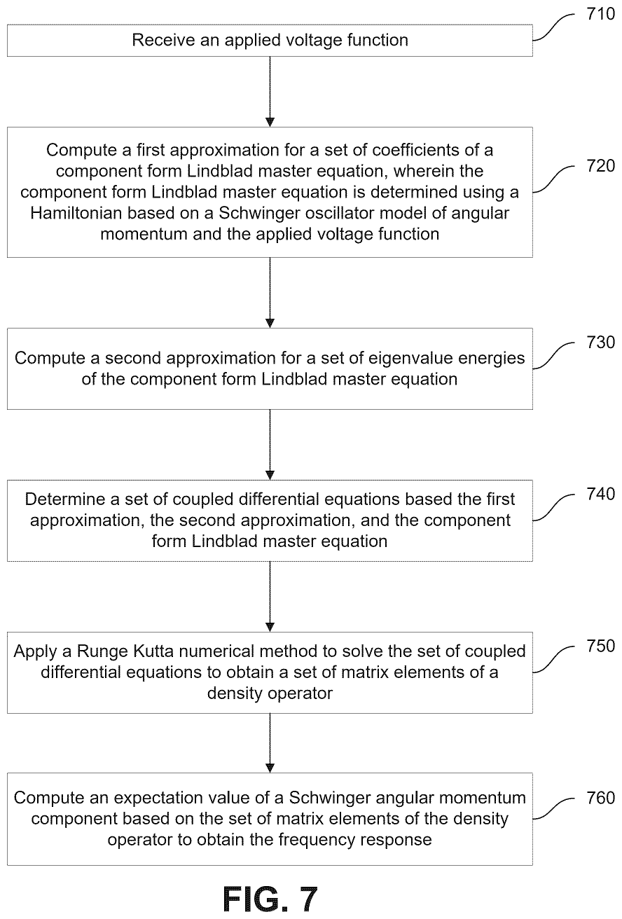

The transmon frequency response system 502 (described previously with reference to FIG. 1) may be embodied by one or more computing devices or servers, shown as apparatus 600 in FIG. 2. The apparatus 600 may be configured to execute various operations described above in connection with FIG. 1 and below in connection with FIG. 7. As illustrated in FIG. 2, the apparatus 600 may include processor 602, memory 604, communications hardware 606, matrix element circuitry 608, and solver circuitry 610, each of which will be described in greater detail below.

The processor 602 (and/or co-processor or any other processor assisting or otherwise associated with the processor) may be in communication with the memory 604 via a bus for passing information amongst components of the apparatus. The processor 602 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 600, remote or “cloud” processors, or any combination thereof.

The processor 602 may be configured to execute software instructions stored in the memory 604 or otherwise accessible to the processor. In some cases, the processor may be configured to execute hard-coded functionality. As such, whether configured by hardware or software methods, or by a combination of hardware with software, the processor 602 represent an entity (e.g., physically embodied in circuitry) capable of performing operations according to various embodiments of the present invention while configured accordingly. Alternatively, as another example, when the processor 602 is embodied as an executor of software instructions, the software instructions may specifically configure the processor 602 to perform the algorithms and/or operations described herein when the software instructions are executed.

Memory 604 is non-transitory and may include, for example, one or more volatile and/or non-volatile memories. In other words, for example, the memory 604 may be an electronic storage device (e.g., a computer readable storage medium). The memory 604 may be configured to store information, data, content, applications, software instructions, or the like, for enabling the apparatus to carry out various functions in accordance with example embodiments contemplated herein.

The communications hardware 606 may be any means such as a device or circuitry embodied in either hardware or a combination of hardware and software that is configured to receive and/or transmit data from/to a network and/or any other device, circuitry, or module in communication with the apparatus 600. In this regard, the communications hardware 606 may include, for example, a network interface for enabling communications with a wired or wireless communication network. For example, the communications hardware 606 may include one or more network interface cards, antennas, buses, switches, routers, modems, and supporting hardware and/or software, or any other device suitable for enabling communications via a network. Furthermore, the communications hardware 606 may include the processing circuitry for causing transmission of such signals to a network or for handling receipt of signals received from a network.

The communications hardware 606 may further be configured to provide output to a user and, in some embodiments, to receive an indication of user input. In this regard, the communications hardware 606 may comprise a user interface, such as a display, and may further comprise the components that govern use of the user interface, such as a web browser, mobile application, dedicated client device, or the like. In some embodiments, the communications hardware 606 may include a keyboard, a mouse, a touch screen, touch areas, soft keys, a microphone, a speaker, and/or other input/output mechanisms. The communications hardware 606 may utilize the processor 602 to control one or more functions of one or more of these user interface elements through software instructions (e.g., application software and/or system software, such as firmware) stored on a memory (e.g., memory 604) accessible to the processor 602.

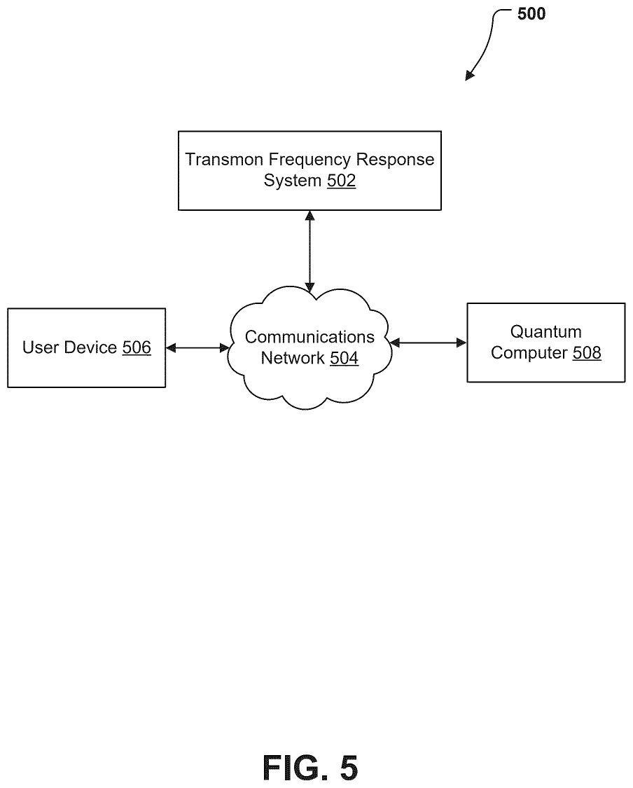

In addition, the apparatus 600 further comprises a matrix element circuitry 608 that computes matrix element values used for the frequency response determination. The matrix clement circuitry 608 may utilize processor 602, memory 604, or any other hardware component included in the apparatus 600 to perform these operations, as described in connection with FIG. 7 below. The matrix clement circuitry 608 may further utilize communications hardware 606 to gather data from a variety of sources (e.g., user device 506, shown in FIG. 5), and/or exchange data with a user, and in some embodiments may utilize processor 602 and/or memory 604 to manipulate and determine values of matrix elements.

In addition, the apparatus 600 further comprises a solver circuitry 610 that applies Runge Kutta or other numerical methods to solve systems of equations. The matrix element circuitry 608 may utilize processor 602, memory 604, or any other hardware component included in the apparatus 600 to perform these operations, as described in connection with FIG. 7 below. The matrix element circuitry 608 may further utilize communications hardware 606 to gather data from a variety of sources (e.g., user device 506, shown in FIG. 5), and/or exchange data with a user, and in some embodiments may utilize processor 602 and/or memory 604 to solve systems of equations.

Although components 602-610 are described in part using functional language, it will be understood that the particular implementations necessarily include the use of particular hardware. It should also be understood that certain of these components 602-610 may include similar or common hardware. For example, the matrix element circuitry 608 and solver circuitry 610 may each at times leverage use of the processor 602, memory 604, or communications hardware 606, such that duplicate hardware is not required to facilitate operation of these physical elements of the apparatus 600 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 600 to perform the various functions described herein.

Although the matrix element circuitry 608 and solver circuitry 610 may leverage processor 602, memory 604, or communications hardware 606 as described above, it will be understood that any of matrix element circuitry 608 and solver circuitry 610 may include one or more dedicated processor, specially configured field programmable gate array (FPGA), or application specific interface circuit (ASIC) to perform its corresponding functions, and may accordingly leverage processor 602 executing software stored in a memory (e.g., memory 604), or communications hardware 606 for enabling any functions not performed by special-purpose hardware. In all embodiments, however, it will be understood that matrix element circuitry 608 and solver circuitry 610 comprise particular machinery designed for performing the functions described herein in connection with such elements of apparatus 600.

In some embodiments, various components of the apparatuses 600 may be hosted remotely (e.g., by one or more cloud servers) and thus need not physically reside on the apparatus 600. For instance, some components of the apparatus 600 may not be physically proximate to the other components of apparatus 600. Similarly, some or all of the functionality described herein may be provided by third party circuitry. For example, a given apparatus 600 may access one or more third party circuitries in place of local circuitries for performing certain functions.

As will be appreciated based on this disclosure, example embodiments contemplated herein may be implemented by an apparatus 600. Furthermore, some example embodiments may take the form of a computer program product comprising software instructions stored on at least one non-transitory computer-readable storage medium (e.g., memory 604). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 600 as described in FIG. 2, that loading the software instructions onto a computing device or apparatus produces a special-purpose machine comprising the means for implementing various functions described herein.

Having described specific components of example apparatuses 600, example embodiments are described below in connection with a series of graphical user interfaces and flowcharts.

### Example Operations

Turning to FIG. 7, example flowcharts are illustrated that contain example operations implemented by example embodiments described herein. The operations illustrated in FIG. 7 may, for example, be performed by the transmon frequency response system 502 shown in FIG. 5, which may in turn be embodied by an apparatus 600, which is shown and described in connection with FIG. 6. To perform the operations described below, the apparatus 600 may utilize one or more of processor 602, memory 604, communications hardware 606, matrix element circuitry 608, solver circuitry 610, and/or any combination thereof. It will be understood that user interaction with the transmon frequency response system 502 may occur directly via communications hardware 606 or may instead be facilitated by a separate user device 506, as shown in FIG. 5, and which may have similar or equivalent physical componentry facilitating such user interaction.

In FIG. 7, example operations are shown for computing a frequency response spectrum for a superconducting transmon. As shown by operation 710, the apparatus 600 includes means, such as communications hardware 606, or the like, for receiving an applied voltage function. For example, communications hardware 606 may receive data indicative of a function such as V(t) as described in EQ. 10. The applied voltage may be given by any function, examples include the single-tone and two-tone voltage functions described in connection with example embodiments disclosed herein.

As shown by operation 720, the apparatus 600 includes means, such as matrix element circuitry 608, or the like, for computing a first approximation for a set of coefficients of a component form Lindblad master equation (e.g., EQS. 14-15). The component form Lindblad master equation may be determined using a Hamiltonian based on a Schwinger oscillator model of angular momentum (e.g., EQS. 4-9) and the applied voltage function (e.g., via a time-dependent energy term shown in EQS. 10-11).

In some embodiments, the matrix element circuitry 608 may prepare for subsequent steps by first determining a canonical form Lindblad master equation (e.g., EQ. 12) based on a set of jump operators (e.g., EQ. 13). The Hamiltonian may include a time-independent Hamiltonian component and a time-dependent Hamiltonian component, taking the form [symbol] (t)= [symbol] ₒ+ [symbol] (t). The matrix clement circuitry 608 may further determine the component form Lindblad master equation based on the canonical form Lindblad master equation by on defining matrix elements of a density operator using energy states of the time-independent Hamiltonian.

As discussed previously, to simplify the component form Lindblad master equation, the matrix element circuitry 608 may truncate components of the component form Lindblad master equation that have weak coupling with the applied voltage function.

The matrix element circuitry 608 may prepare the time-independent component of the Hamiltonian based on the Swinger oscillator model of angular momentum. The matrix element circuitry 608 may determine a second-quantized Hamiltonian using a Schwinger oscillator model of angular momentum, and the second-quantized Hamiltonian may be based on two capacitively coupled oscillators of the superconducting transmon. The matrix element circuitry 608 may subsequently apply a canonical transformation to the second-quantized Hamiltonian to diagonalize linear terms to produce the time independent Hamiltonian.

In some embodiments, the matrix element circuitry 608 may further prepare the time-dependent component of the Hamiltonian based on the applied voltage function. The matrix element circuitry 608 may determine a time-dependent energy term based on the applied voltage function and a charge of a resonator of the superconducting transmon, and subsequently determine a canonical form of the time-dependent energy term to produce the time dependent Hamiltonian.

The first approximation may determine approximations of coefficients, including Θ_{k,k′}, a matrix coefficient of a Θ operator comprising an annihilation operator, a creation operator, and fundamental frequencies of the Schwinger oscillator. The approximated coefficients may further include A_{k,k′}(σ, s), an expectation value of a jump operator for the Lindblad master equation. The approximated coefficients may also include Λ_{k,k′}^{(1,1′)}, a strength of interaction with surroundings of the superconducting transmon based on the jump operator. In embodiments that describe a two-particle system, the first approximation of the coefficients described here may be based on setting eigenstates of a two-particle system to be angular momentum eigenstates in the Schwinger oscillator model, for example, taking |ψ₁ [symbol] ≅|0,0 [symbol] and |ψ₂ [symbol] ≅|1/2,−1/2).

In some embodiments, the first approximation may use second-order perturbation theory to estimate the eigenstates and eigenvalues.

As shown by operation 730, the apparatus 600 includes means, such as matrix element circuitry 608, or the like, for computing a second approximation for a set of eigenvalue energies of the component form Lindblad equation (e.g., EQS. 14-15). For example, eigenvalue energies may be approximated using EQ. 7. For the two-state example system described earlier, EQ. 7 may be used such that ϵ₁≅ξ_{0,0} and ϵ₂≅ϵ_{1/2,-1/2}. In some embodiments, the second approximation may use second-order perturbation theory to estimate the eigenstates and eigenvalues.

As shown by operation 740, the apparatus 600 includes means, such as matrix element circuitry 608, or the like, for determining a set of coupled differential equations based the first approximation, the second approximation, and the component form Lindblad master equation. In some embodiments, the coupled differential equations may be determined by combining the estimated values of the coefficients and/or eigenstates, the estimated eigenvalues, and the component form Lindblad equation (e.g., EQS. 14-15), which is based on the Lindblad master equation.

As shown by operation 750, the apparatus 600 includes means, such as solver circuitry 610, or the like, for applying a Runge Kutta numerical method to solve the set of coupled differential equations to obtain a set of matrix elements of a density operator. The solver circuitry 610 may use a numerical method to find a solution to the set of coupled differential equations, resulting in numerical estimates of the matrix elements and density operator components. In some embodiments, other numerical methods may be used, including any numerical methods known in the art.

As shown by operation 760, the apparatus 600 includes means, such as matrix element circuitry 608, or the like, for computing an expectation value of a Schwinger angular momentum component (e.g., [symbol] S_{z}(t) [symbol] ) based on the set of matrix elements of the density operator (e.g., ρ_{k,k′}(t) to obtain the frequency response spectrum. For example, the value of [symbol] S_{z}(t) [symbol] may be computed for a particular time. In some embodiments, the values may be estimated for a steady-state approximation by computing an estimate of a time evolution of the set of matrix elements for ₜ→∞. Subsequently, the matrix element circuitry 608 may proceed by computing a steady state expectation value of the Schwinger angular momentum component based on the set of steady-state matrix elements to obtain the frequency response spectrum (e.g., the steady-state frequency response spectrum).

Finally, the apparatus 600 may cause a change in a quantum state of a superconducting transmon based on the frequency response spectrum. For example, the frequency response spectrum may be transmitted via communications hardware 606 to quantum computer 508 to re-calibrate or re-configure the device based on an improved frequency response calculation. In some embodiments, the processor 602 may compute various optimizations particular to the hardware of the quantum computer 508 based on the computed frequency response spectrum, and transmit the optimizations to quantum computer 508 for implementation, which may in turn improve the effectiveness and/or reduce error rates of gate operations, state measurements, and/or the like. In doing so, example implementations therefore offer meaningful performance improvements to the functioning of the quantum computer 508 itself.

### Conclusion

Disclosed herein are systems and methods that define the qubit of a superconducting transmon by leveraging its proximity to a resonator readout. In this approach the qubit is defined as a measure of photon entanglement, via the use of the Schwinger oscillator model of angular momentum. The Schwinger oscillator construct of angular momentum provides a natural and robust description of a qubit, applicable to a multilevel model of transmon and resonator energy states. It is not restricted to a spin-1/2 representation and can be considered a definition for an emergent property of the combined transmon-resonator system.

The Schwinger construct introduces angular-momentum, atom-like symmetry, corresponding to underlying conservation of total photon number, N, as a basis from which to construct the combined transmon-resonator wave function, and thereby, the expectation value of the qubit. This basis provides a convenient starting point from which to study the error-inducing effects of transmon anharmonicity, surrounding-environment decoherence, and random stray fields on qubit state. Specifically, even in the presence of weak transmon anharmonicity, selection rules exist for photon state transitions. In particular, as shown by plot 120 of FIG. 1, transitions between states that change S=N/2 by a half-integer, or equivalently, change N by an odd number, are forbidden. This implies, for example, that the superconducting transmon tends to be robust against random one-half noise events because such events represent forbidden one-photon transitions. As transom anharmonicity increases, and the effects of symmetry breaking become stronger, these forbidden transitions become less strict.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for computing a frequency response spectrum for a superconducting transmon, the method comprising:
receiving, by communications hardware, an applied voltage function;
computing, by matrix element circuitry, a first approximation for a set of coefficients of a component form Lindblad master equation, wherein the component form Lindblad master equation is determined using a Hamiltonian based on a Schwinger oscillator model of angular momentum and the applied voltage function;
computing, by the matrix element circuitry, a second approximation for a set of eigenvalue energies of the component form Lindblad master equation;
determining, by solver circuitry, a set of coupled differential equations based the first approximation, the second approximation, and the component form Lindblad master equation;
applying, by the solver circuitry, a Runge Kutta numerical method to solve the set of coupled differential equations to obtain a set of matrix elements of a density operator;
computing, by the matrix element circuitry, an expectation value of a Schwinger angular momentum component based on the set of matrix elements of the density operator to obtain the frequency response spectrum; and
causing a change in a quantum state of the superconducting transmon based on the frequency response spectrum.

2. The method of claim 1, wherein the set of coefficients comprises:
Θ_{k,k′}, a matrix coefficient of a Θ operator comprising an annihilation operator, a creation operator, and fundamental frequencies of the Schwinger oscillator;
A_{k,k′}(σ, s), an expectation value of a jump operator for the Lindblad master equation; and
Λ_{k,k′}^{(1,1′)}, a strength of interaction with surroundings of the superconducting transmon based on the jump operator,
wherein the first approximation is based on setting eigenstates of a two-particle system to be angular momentum eigenstates in the Schwinger oscillator model.

3. The method of claim 2, wherein computing the second approximation comprises:
computing the set of eigenvalue energies based on eigenvalues of the angular momentum eigenstates in the Schwinger oscillator model.

4. The method of claim 1, wherein the first approximation and the second approximation use second-order perturbation theory.

5. The method of claim 1, further comprising:
determining a canonical form Lindblad master equation based on a set of jump operators and the Hamiltonian comprising a time-independent Hamiltonian and a time-dependent Hamiltonian;
determining the component form Lindblad master equation based on the canonical form Lindblad master equation based on defining matrix elements of a density operator using energy states of the time-independent Hamiltonian; and
truncating components of the component form Lindblad master equation that have weak coupling with the applied voltage function.

6. The method of claim 5, further comprising:
determining a second-quantized Hamiltonian using a Schwinger oscillator model of angular momentum, wherein the second-quantized Hamiltonian is based on two capacitively coupled oscillators of the superconducting transmon; and
applying a canonical transformation to the second-quantized Hamiltonian to diagonalize linear terms to produce the time-independent Hamiltonian.

7. The method of claim 5, further comprising:
determining a time-dependent energy term based on the applied voltage function and a charge of a resonator of the superconducting transmon; and
determining a canonical form of the time-dependent energy term to produce the time-dependent Hamiltonian.

8. The method of claim 1, further comprising:
computing an estimate of a time evolution of the set of matrix elements for ₜ→co to obtain a set of steady-state matrix elements.

9. The method of claim 8, further comprising:
computing a steady state expectation value of the Schwinger angular momentum component based on the set of steady-state matrix elements to obtain the frequency response spectrum.

10. The method of claim 1, wherein the superconducting transmon is a two-state system, wherein the applied voltage function is a single-tone voltage function.

11. The method of claim 1, wherein the superconducting transmon is a three-state system, wherein the applied voltage function is a two-tone voltage function.

12. An apparatus for computing a frequency response spectrum of a superconducting transmon, the apparatus comprising:
communications hardware configured to receive an applied voltage function;
matrix element circuitry configured to:
compute a first approximation for a set of coefficients of a component form Lindblad master equation, wherein the component form Lindblad master equation is determined using a Hamiltonian based on a Schwinger oscillator model of angular momentum and the applied voltage function, and
compute a second approximation for a set of eigenvalue energies of the component form Lindblad master equation;
solver circuitry configured to:
determine a set of coupled differential equations based the first approximation, the second approximation, and the component form Lindblad master equation, and
apply a Runge Kutta numerical method to solve the set of coupled differential equations to obtain a set of matrix elements of a density operator,
wherein the matrix element circuitry is further configured to compute an expectation value of a Schwinger angular momentum component based on the set of matrix elements of the density operator to obtain the frequency response spectrum; and
quantum computing circuitry configured to:
cause a change in a quantum state of the superconducting transmon based on the frequency response spectrum.

13. The apparatus of claim 12, wherein the set of coefficients comprises:
Θ_{k,k′}, a matrix coefficient of a Θ operator comprising an annihilation operator, a creation operator, and fundamental frequencies of the Schwinger oscillator;
A_{k,k′}(σ, s), an expectation value of a jump operator for the Lindblad master equation; and
Λ_{k,k′}^{(1,1′)}, a strength of interaction with surroundings of the superconducting transmon based on the jump operator,
wherein the first approximation is based on setting eigenstates of a two-particle system to be angular momentum eigenstates in the Schwinger oscillator model.

14. The apparatus of claim 13, the matrix element circuitry is configured to compute the second approximation by:
computing the set of eigenvalue energies based on eigenvalues of the angular momentum eigenstates in the Schwinger oscillator model.

15. The apparatus of claim 12, wherein the first approximation and the second approximation use second-order perturbation theory.

16. The apparatus of claim 12, wherein the matrix element circuitry is further configured to:
determine a canonical form Lindblad master equation based on a set of jump operators and the Hamiltonian comprising a time-independent Hamiltonian and a time-dependent Hamiltonian;
determine the component form Lindblad master equation based on the canonical form Lindblad master equation based on defining matrix elements of a density operator using energy states of the time-independent Hamiltonian; and
truncate components of the component form Lindblad master equation that have weak coupling with the applied voltage function.

17. The apparatus of claim 16, wherein the matrix element circuitry is further configured to:
determine a second-quantized Hamiltonian using a Schwinger oscillator model of angular momentum, wherein the second-quantized Hamiltonian is based on two capacitively coupled oscillators of the superconducting transmon; and
apply a canonical transformation to the second-quantized Hamiltonian to diagonalize linear terms to produce the time-independent Hamiltonian.

18. The apparatus of claim 16, wherein the matrix element circuitry is further configured to:
determine a time-dependent energy term based on the applied voltage function and a charge of a resonator of the superconducting transmon; and
determine a canonical form of the time-dependent energy term to produce the time-dependent Hamiltonian.

19. The apparatus of claim 12, wherein the matrix element circuitry is further configured to:
compute an estimate of a time evolution of the set of matrix elements for ₜ→∞ to obtain a set of steady-state matrix elements.

20. A computer program product for computing a frequency response spectrum of a superconducting transmon, the computer program product comprising at least one non-transitory computer-readable storage medium storing software instructions that, when executed, cause an apparatus to:
receive an applied voltage function;
compute a first approximation for a set of coefficients of a component form Lindblad master equation, wherein the component form Lindblad master equation is determined using a Hamiltonian based on a Schwinger oscillator model of angular momentum and the applied voltage function;
compute a second approximation for a set of eigenvalue energies of the component form Lindblad master equation;
determine a set of coupled differential equations based the first approximation, the second approximation, and the component form Lindblad master equation;
apply a Runge Kutta numerical method to solve the set of coupled differential equations to obtain a set of matrix elements of a density operator, and
compute an expectation value of a Schwinger angular momentum component based on the set of matrix elements of the density operator to obtain the frequency response spectrum.
